(19) United States
(12) Patent Application Publication
(10) Pub. No.: US 2022/0393255 A1
(43) Pub. Date: Dec. 8, 2022

(54) PREPARATION METHOD OF FLAME-RETARDANT LITHIUM-ION BATTERY ELECTROLYTE EASILY SOLUBLE IN ORGANIC SOLVENT

(71) Applicant: SHANDONG UNIVERSITY OF TECHNOLOGY, Zibo (CN)

(72) Inventors: Zhongfang LI, Zibo (CN); Peng SUN, Zibo (CN); Weihui CUI, Zibo (CN); Chuangang WANG, Zibo (CN); Hui GUO, Zibo (CN); Yan WANG, Zibo (CN)

(73) Assignee: SHANDONG UNIVERSITY OF TECHNOLOGY, Zibo (CN)

(21) Appl. No.: 17/639,576

(22) PCT Filed: Jan. 11, 2020
(86) PCT No.: PCT/CN2020/071575

§ 371 Date: Aug. 4, 2022

(51) Int. Cl. H01M 10/42; H01M 10/0525; H01M 10/0568; H01M 10/0569; H01M 10/0567; C08G 79/025

(52) U.S. Cl. CPC H01M 10/4235; H01M 10/0525; H01M 10/0568; H01M 10/0569; H01M 10/0567; C08G 79/025; H01M 2300/0037

(57) ABSTRACT

A lithium salt easily soluble in an organic solvent and having a flame-retardant function and a lithium-ion battery flame-retardant electrolyte thereof are provided. The lithium salt is poly(lithium phosphate) phosphazene partially substituted by alkyl aromatic oxy groups, and has a structural general formula: [(R—Ar—O)ₓ(P═N)ₙ(Li₂O₃P)₂ₙ₋ₓ]. The novel flame-retardant electrolyte is compounded from the lithium salt and a phosphate intermediate thereof [(R—Ar—O)ₓ(P═N)ₙ(R′₂O₃P)₂ₙ₋ₓ] according to a mass ratio of 10:1-1:1. The electrolyte is easily soluble in an organic solvent. A liquid electrolyte is prepared according to an amount of 8%-45% to obtain the novel flame-retardant liquid electrolyte. The liquid electrolyte has good lithium ion conductivity and good flame-retardant properties, and is used in lithium-ion batteries, lithium-sulfur batteries, lithium carbon fluoride batteries or lithium-oxygen batteries.

### TECHNICAL FIELD

The invention relates to preparation of a flame-retardant electrolyte for lithium batteries. The electrolyte has high lithium-ion conductivity and has a flame-retardant function, which is of great significance for improving safety performance of lithium-ion batteries. The electrolyte can be used for lithium-ion batteries, lithium-oxygen batteries and lithium-sulfur batteries.

### BACKGROUND ART

Organic liquid electrolytes are used in lithium-ion batteries, lithium-sulfur batteries and lithium-oxygen batteries. Due to the wide application of lithium-ion batteries, the research on the liquid electrolytes of lithium-ion batteries has attracted widespread attention. In a lithium-ion battery, the liquid electrolyte, as an important part of the lithium-ion battery, plays a very important role in the movement of lithium ions between the cathode and the anode, and determines the properties of the lithium-ions batteries. As an important part of the liquid electrolyte, lithium salt is an important factor affecting the properties of the liquid electrolyte. Among commonly used lithium salts, such as lithium perchlorate (LiClO₄), lithium hexafluorophosphate (LiPF₆) and lithium tetrafluoroborate (LiBF₄), LiPF₆ is the most used. However, LiPF₆ is low in conductivity and decomposes in water, which reduces the conductivity, and produces swelling of the battery. Therefore, it is an important research topic to develop and research a novel lithium salt with high conductivity and stability to water. Since the working voltage of the battery is much higher than the decomposition voltage of water, organic solvents, such as diethyl ether, ethylene carbonate, propylene carbonate, diethyl carbonate and the like, are commonly used for lithium-ion batteries. Organic solvents often destroy the structure of graphite during charging, causing peeling of the graphite, a solid electrolyte interphase (SEI) is formed on the surface of the graphite, causing electrode passivation. Organic solvents also bring safety problems such as flammability, explosiveness and the like. Different types of lithium salts in the liquid electrolyte and their different solvation states in the solution will have an important impact on the film-forming properties of the electrode/liquid electrolyte interface, the migration behavior of lithium ions and the like, and then significantly affect the electrochemical properties of the liquid electrolyte. LiPF₆ is currently the most widely used electrolyte lithium salt in commercial lithium-ion batteries. LiPF₆ has high conductivity and a wide electrochemical stability window, and can form an SEIon the carbon anode. However, the synthesis process of LiPF₆ is complex, involving high and low temperature treatment, water-free and oxygen-free operation, strong corrosion protection and other production links, and thus, is difficult. Besides, LiPF₆ is easily hydrolyzed, and has high requirements for equipment and operation. Therefore, a novel electrolyte lithium salt is to be developed.

CN201711433412.4 discloses a provided lithium-ion battery and a liquid electrolyte thereof. By adding a cyano-containing anti-overcharge additive to the liquid electrolyte, the anti-overcharge ability of the lithium-ion battery is improved, and the safety of the lithium-ion battery is ensured. At present, the lithium salts adopted usually have the problems of high price, poor thermal stability, easy decomposition in water, and the like. Therefore, it is necessary to develop a lithium salt with better properties.

Flame retardants commonly used in lithium-ion batteries can be roughly separated into phosphorus-containing flame retardants, fluorine-containing flame retardants, nitrogen-containing flame retardants and composite flame retardants. Trimethyl phosphate (TMP) and triethyl phosphate (TEP) are the earliest flame retardant additives applied to lithium-ion batteries. They have a good flame-retardant effect, but are likely to cause peeling of the carbon anode due to the high phosphorus content, which affects the cycle performance of the battery. At present, there is no report about flame-retardant lithium salts. Cyclophosphazenes are six-membered cyclic compounds formed by alternate connection of nitrogen-phosphorus single and double bonds, have a special molecular structure and a stable chemical structure, and thus, have excellent thermal stability. Cyclophosphazenes can undergo ring-opening polymerization reaction to synthesize an organic-inorganic polymer material having wider functions, and have good flame-retardant effect. The cyclophosphazenes can also be used in catalytic materials, high-temperature-resistant rubber, flame-retardant materials, polymer electrolytes, photoconductive polymer materials, nonlinear optical materials, biomedical polymer materials, polymer liquid crystals, separation membranes, medicine, military industry, and the like. Feng Jinkui et al. (CN201810377913.3) reported a preparation method of polyphosphazene, in which conversion of hexachlorocyclotriphosphazene into alkyl or alkoxycyclotriphosphazene for a lithium-ion battery additive under different catalysts. Wang Xiufen et al. (CN 201810139149.6) reported a method for controlling molecular weight of a linear polyphosphazene intermediate, in which a linear polyphosphazene intermediate with a number average molecular weight Mn of 1×10⁴-9×10⁵, is prepared by carrying out ring-opening polymerization of hexachlorocyclotriphosphazene using trichlorobenzene as a solvent and aminosulfonic acid as a catalyst. Zeng Heping (CN201410007691.8) disclosed a production method of a water-based organic polyphosphazene resin. The production method is simple and convenient, is low in cost, and does not need any additional flame retardant. The produced resin has good high-temperature resistance and flame-retardant properties. Miao Wei et al. (CN201610870501.4) disclosed a preparation method of a polyphosphazene modified phenolic resin, in which the system can form an interpenetrating network to improve thermal stability and flame-retardant properties. The phosphazene molecule contains two flame-retardant components, phosphorus and nitrogen, which can work together to play a flame-retardant effect. Besides, the phosphazene can undergo endothermic degradation to generate phosphate compounds and non-combustible gases, and form a non-volatile dense protective film on the surface of the flame-retardant material to isolate air, thereby inhibiting combustion.

### SUMMARY

The invention provides a novel lithium salt [(R—Ar—O)ₓ(P═N)ₙ(Li₂O₃P)₂ₙ₋ₓ] easily soluble in an organic solvent. The lithium salt is a kind of lithium salt easily soluble in an organic solvent and having a flame-retardant function. The lithium salt has the following characteristics: (1) the polymer molecule has poly(lithium phosphate) phosphazene partially substituted by alkyl aromatic oxy groups, and since the lithium salt molecule has a large number of aromatic groups, the solubility of the lithium salt in an organic solvent is improved; (2) the solubility of the lithium salt in the organic solvent is regulated by controlling an amount of substitution of aromatic oxy groups in the molecule; (3) due to the aromatic ring, compatibility of the lithium salt with an electrode material is improved; (4) since the molecule contains lots of lithium ions that are releasable by ionization, the lithium salt has good lithium-ion conductivity; and (5) since the molecule contains a polyphosphazene group and a phosphate group with good flame-retardant performance, the salt has good flame-retardant properties. The lithium salt is compounded with a phosphate intermediate thereof ([(R—Ar—O)ₓ(P═N)ₙ(R′₂O₃P)₂₋ₓ]) to obtain the novel flame-retardant electrolyte. The novel flame-retardant electrolyte obtained by addition and compounding based on the lithium-ion battery liquid electrolyte has the following advantages: (1) The lithium salt has good solubility in the organic solvent with a mass percentage up to 45%, and the solubility can be regulated by increasing a number of aryl groups in the molecule. (2) The lithium salt is soluble in water and stable to water, and is not decomposed in water like lithium hexafluorophosphate, which makes the battery swollen. (3) The compounded novel flame-retardant electrolyte contains multiple elements and groups and can have multiple flame-retardant mechanisms, and thus, can have the flame-retardant effect under multiple conditions. (4) The compounded electrolyte contains lithium salt, so the novel flame-retardant electrolyte added has good flame-retardant properties and can improve the conductivity. Unlike the commonly added flame retardant, the conductivity of the liquid electrolyte will be decreased. (5) The [(R—Ar—O)ₓ(P═N)ₙ(R′₂O₃P)₂ₙ₋ₓ] component in the compound has good solubility in the organic solvent, and has good flame-retardant properties itself. The component is added to improve the flame-retardant properties.

A preparation process route of the novel electrolyte includes:

1) A raw material hexachlorocyclotriphosphazene (HCCP) is heated at 210-250° C. in a high-boiling-point solvent to carry out ring-opening polymerization to obtain poly(dichlorophosphazene) (PDCP). The PDCP is dissolved in a specific solvent such as xylene or the like, and reaction is carried out with a certain amount of triphosphite at 100-120° C. to obtain partially phosphated poly(chloro(dialkoxyphosphate)phosphazene) [Clₓ(P═N)ₙ(R′₂O₃P)₂ₙ₋ₓ]; [Clₓ(P═N)ₙ(R′₂O₃P)₂ₙ₋ₓ] is reacted with alkyl aromatic phenolate sodium (R—Ar—ONa) to obtain [(R—Ar—O)ₓ(P═N)ₙ(R′₂O₃P)₂ₙ₋ₓ], and the [(R—Ar—O)ₓ(P═N)ₙ(R′₂O₃P)₂ₙ₋ₓ] is hydrolyzed under alkaline conditions of lithium hydroxide to obtain [(R—Ar—O)ₓ(P═N)ₙ(Li₂O₃P)₂ₙ₋ₓ]; or a second hydrolysis process route includes that: hydrolysis is firstly carried out with a sodium hydroxide solution to obtain a sodium phosphate [(R—Ar—O)ₓ(P═N)ₙ(Na₂O₃P)₂ₙ₋ₓ], cation exchange is carried out with a cation exchange resin to obtain [(R—Ar—O)ₓ(P═N)ₙ(H₂O₃P)₂ₙ₋ₓ] in a phosphoric acid form, and a neutralization reaction is carried out with lithium hydroxide to obtain [(R—Ar—O)ₓ(P═N)ₙ(Li₂O₃P)₂ₙ₋ₓ]. It should be noted that the [(R—Ar—O)(P═N)ₙ(R′₂O₃P)₂ₙ₋ₓ] in a phosphate form structure here cannot be hydrolyzed with concentrated hydrochloric acid because the molecule still contains acid-sensitive phenol-ether bonds.

2) The [(R—Ar—O)ₓ(P═N)ₙ(Li₂O₃P)₂ₙ₋ₓ] is compounded and mixed with [(R—Ar—O)(P═N)ₙ(R′₂O₃P)₂ₙ₋ₓ] according to a certain ratio, and the mixture is dissolved in a suitable organic solvent to obtain an additive of the novel flame-retardant lithium-ion battery electrolyte.

3) The novel flame-retardant electrolyte additive obtained in step 2) is added to a commercially available liquid electrolyte with no lithium salt or flame retardant added originally to obtain the novel flame-retardant liquid electrolyte. The liquid electrolyte has good flame-retardant properties, higher lithium-ion conductivity and better compatibility with electrodes. The battery assembled with the electrolyte has better battery performance, and higher flame-retardant properties and safety performance. The liquid electrolyte is used as an electrolyte for lithium-ion batteries, lithium-oxygen batteries and lithium-sulfur batteries.

The specific preparation method is as follows:

(1) Preparation of poly(dichlorophosphazene)

Under the protection of nitrogen, sulfamic acid (0.52 mmol, 0.05 g), hexachlorocyclotriphosphazene (HCCP) (14.4 mmol, 5 g) and a solvent diphenyl ether (15-30 mL) are respectively added into a three-necked flask equipped with a stirrer and a condenser pipe. After introducing nitrogen for 20-40 min, the mixture is stirred and heated to 210-250° C. to carry out ring-opening polymerization reaction. When the solution becomes viscous, heating is stopped. The mixture is cooled and poured into a beaker containing 40-60 mL of petroleum ether to remove the unreacted raw material HCCP. The mixture is washed with petroleum ether three times before the suction filtration is carried out, and the obtained solid product is dried in a vacuum drying oven at 70-90° C. for 4-8 h to obtain poly(dichlorophosphazene) (PDCP). The reaction equation is as follows:

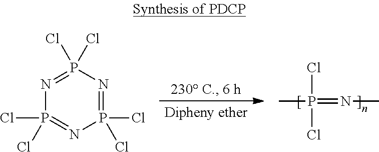

(2) Preparation of poly(chloro(dialkoxyphosphate)phosphazene) [Clₓ(P═N)ₙ(R′₂O₃P)₂ₙ₋ₓ]

The poly(dichlorophosphazene) (5.8 g) with an element chlorine content of 0.1 mol and 0.1 mol of triethylphosphite (16.6 g) are respectively weighed and dissolved in 100 mL of xylene (dried). The two solutions are mixed in a three-necked flask equipped with a stirrer, a condenser pipe and a heating device under stirring, stirred and reacted at 100-120° C. for 5-7 h. After the solvent is removed by evaporation, the reaction mixture is washed with an appropriate amount of petroleum ether 3-4 times to remove impurities, suction filtration is carried out, and the solid is dried in a vacuum drying oven at 60-100° C. to obtain a solid powder product [Clₙ(P═N)ₙ(R′₂O₃P)ₙ]. According to the molar ratio of the number of moles of the element chlorine to the phosphite of 4:1-1:4, raw materials in different molar ratios are adopted to obtain the [Clₓ(P═N)ₙ(R′₂O₃P)₂ₙ₋ₓ].

For different n and x value ranges, the reaction equations are as follows:

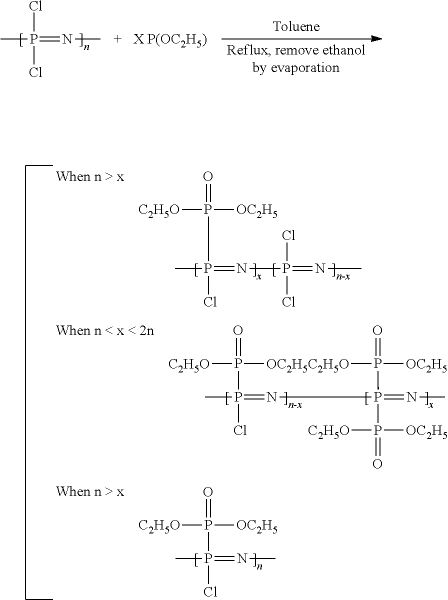

Using the same method above, other phosphate compounds can be obtained by replacing ethyl phosphite with other phosphites (one or a mixture of several of trimethylphosphite, tripropylphosphite or triisopropylphosphite).

(3) Synthesis of Intermediate [(R—Ar—O)ₓ(P═N)ₙ(R′₂O₃P)₂ₙ₋ₓ]

In a three-necked flask equipped with electric stirring and a condenser pipe under the protection of nitrogen, 0.1 mol (21.75 g) of the [Clₙ(P═N)ₙ(R′₂O₃P)ₙ] in the experiment of (2) above is dissolved in tetrahydrofuran, the solution is slowly added dropwise to 0.11 mol (17.38 g) of p-isopropyl-phenolate sodium in tetrahydrofuran, and the mixture is stirred at 80° C. to react for 24 h. After the completion of the reaction, the reaction mixture is cooled and neutralized with glacial acetic acid to neutrality, the mixture is stood and cooled in an ice water bath to separate a crystal, suction filtration is carried out, and the obtained crude product is recrystallized with tetrahydrofuran to obtain the pure product white crystal [(CH₃)₂CH-ph-O)ₙ(P═N)ₙ(C₂H₅)₂O₃P)ₙ]. Using the same method, different structures of [(CH₃)₂CH-ph-O)ₓ(P═N)ₙ(C₂H₅)₂O₃P)₂ₙ₋ₓ] can be obtained by selecting different mass ratios.

According to the above reactions, [(R—Ar—O)ₓ(P═N)ₙ(R′₂O₃P)₂ₙ₋ₓ] can be obtained by using other ratios of raw materials and different alkyl aromatic oxy phenolates.

(4) Preparation of novel flame-retardant lithium salt [(R—Ar—O)ₓ(P═N)ₙ(R′₂O₃P)₂ₙ₋ₓ] by hydrolysis of intermediate [(R—Ar—O)ₓ(P═N)ₙ(Li₂O₃P)₂ₙ₋ₓ].

[Method I] Hydrolysis in Lithium Hydroxide Solution

According to the method, an excess of lithium hydroxide is needed. A certain amount of [(R—Ar—O)ₓ(P═N)ₙ(R′₂O₃P)₂ₙ₋ₓ] is weighed and dispersed in a 2 mol/L lithium hydroxide solution. The mixture is heated, stirred and refluxed for 24 h. After ethanol generated by the hydrolysis reaction is removed by evaporation, the mixture is concentrated, cooled and stood overnight to obtain a crude product. The crude product is recrystallized twice with an ethanol-water mixed solution to obtain a colorless crystal [(R—Ar—O)ₓ(P═N)ₙ(Li₂O₃P)₂ₙ₋ₓ] The mother liquor uses a cation exchange resin to collect and recover lithium ions.

[Method II] Hydrolysis in Sodium Hydroxide Solution.

Method II is the same as Method I, except that: the lithium hydroxide solution is replaced by a sodium hydroxide solution to obtain the colorless crystal sodium phosphate [(R—Ar—O)ₓ(P═N)ₙ(Na₂O₃P)₂ₙ₋ₓ], and a solution prepared from the sodium phosphate is exchanged with a cation exchange resin for 24 h to obtain [(R—Ar—O)ₓ(P═N)ₙ(H₂O₃P)₂ₙ₋ₓ], and the acid structure is reacted with an equimolar amount of lithium hydroxide (or a slight excess amount, the pH of the solution is 9-11) to obtain the colorless crystal [(R—Ar—O)ₓ(P═N)ₙ(Li₂O₃P)₂ₙ₋ₓ] product. The process can minimize the use of the raw material lithium hydroxide.

Reaction equations of steps (3) and (4) are as follows:

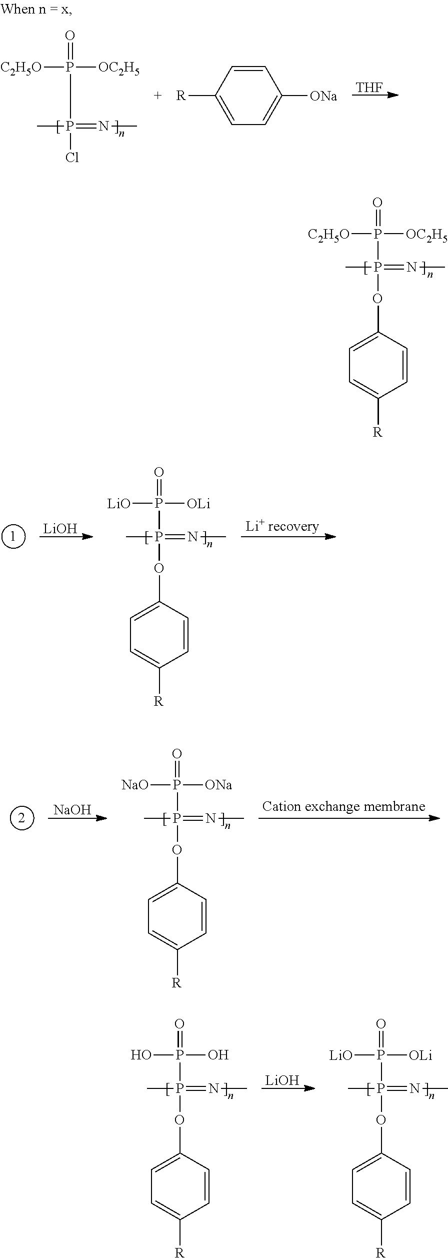

Using the above method, other phenolates may be used instead of alkylphenylphenolate (the other phenolates are: R in the aromatic phenolate (R—Ar—ONa) is C₁-C₈ alkyl, disubstituted C₁-C₈ alkyl or CH₂═CH—(CH₂)ₙ— (n=1-6); and Ar is one or a mixture of several of ph-, -ph-, naphthyl, disubstituted naphthyl, furyl, pyridyl, pyrazinyl, thienyl, imidazolyl and benzimidazolyl.) to obtain products substituted by other phenolates.

It should be noted that the [(R—Ar—O)ₓ(P═N)ₙ(R′₂O₃P)₂ₙ₋ₓ] in a phosphate form here cannot be hydrolyzed with concentrated hydrochloric acid because the molecule still contains acid-sensitive phenol-ether bonds.

(5) Research of Compounding Process of Electrolyte

The [(R—Ar—O)ₓ(P═N)ₙ(Li₂O₃P)₂ₙ₋ₓ] is mixed and compounded with the [(R—Ar—O)ₓ(P═N)ₙ(R′₂O₃P)₂ₙ₋ₓ] according to a mass ratio of 10:1-1:1; and the mixture is dissolved in a suitable organic solvent. The solvent used is as follows: one or a mixture of several of methyl carbonate, ethyl carbonate, propyl carbonate, ethylene carbonate, fluoroethylene carbonate, dimethylsulfoxide, dimethylformamide, dimethylacetamide and N-methylpyrrolidone is used as the solvent of the electrolyte. The solution in which the novel flame-retardant electrolyte is dissolved is used as the additive of the novel flame-retardant lithium-ion battery electrolyte.

(6) Preparation of Liquid Electrolyte

(a) Preparation of Liquid Electrolyte

According to the novel flame-retardant electrolyte additive obtained in step (5), a series of lithium-ion battery additives are added, for example an anti-overcharge additive, such as one or a mixture of several of diacetylferrocene, transition metal complex of bipyridine, terpyridine or o-phenanthroline, anisole, cyclohexylbenzene and N-phenylmaleimide, with a mass percentage of 6%-25%; and an additive that promotes formation of an SEI, such as one or mixture of several of fluoroethylene carbonate, fluoropropylene carbonate, nonafluorobutyl ethyl ether, butane sultone, 1,3-propane sultone, vinyltrimethoxysilane, 2-phenylimidazole and 4-fluorophenylisocyanate, with a mass percentage of 4%-20%.

(b) Performance Test of Liquid Electrolyte

The liquid electrolyte is tested for various physical and chemical performance indicators, such as viscosity, flame-retardant properties, lithium-ion conductivity and other properties. The formula and compounding process of the liquid electrolyte are improved through the performance test to seek a preparation process of a liquid electrolyte with more excellent performance.

(7) Assembly and Performance Test of Battery

The battery assembled with the novel flame-retardant liquid electrolyte is tested for battery performance, initial power generation performance, charge and discharge performance at different rates, cycle stability, battery overheating resistance, puncture resistance, anti-overcharge performance and the like.

(8) Performance of Assembled Lithium-Sulfur Battery and Lithium-Oxygen Battery

The lithium-sulfur battery and the lithium-oxygen battery assembled with the novel flame-retardant liquid electrolyte are respectively tested for battery performance. Various aspects of the performance of the novel flame-retardant liquid electrolyte are investigated. The experiments prove that the battery performance and safety are greatly improved.

### DETAILED DESCRIPTION

### [Example 1]: Preparation of poly(dichlorophosphazene)

Under the protection of nitrogen, sulfamic acid (0.52 mmol, 0.05 g), hexachlorocyclotriphosphazene (HCCP) (14.4 mmol, 5 g) and a solvent diphenyl ether (15-30 mL) were respectively added into a three-necked flask equipped with a stirrer and a condenser pipe. After introducing nitrogen for 20-40 min, the mixture was stirred and heated to 210-250° C. to carry out ring-opening polymerization reaction. When the solution became viscous, heating was stopped, the mixture was cooled and poured into a beaker containing 40-60 mL of petroleum ether to remove the unreacted raw material HCCP, the mixture was washed with petroleum ether three times, suction filtration was carried out, and the obtained solid product was dried in a vacuum drying oven at 70-90° C. for 4-8 h to obtain poly(dichlorophosphazene) (PDCP). The obtained PDCP had a yield of 70% and a viscosity average molecular weight of 60000-80000.

By using the above method, the ring-opening polymerization product may also be obtained by replacing the diphenyl ether with other solvents (one or a mixture of several of aromatic solvent oil, sulfolane, glyceryl triacetate, pentaerythritoltetraacetate, polyethylene glycol diacetate, liquid paraffin and methylnaphthalene oil) and by controlling the temperature at 210-250° C. or a higher reaction temperature, only except that the solvent would be removed by washing the solvent using a low-boiling-point solvent with better solubility for the solvent.

The yield of the ring-opening polymerization reaction using different solvents was in the range of 40%-80%, and the viscosity average molecular weight was in the range of 40000-100000.

### [Example 2]: Preparation of poly(chloro(dialkoxyphosphate)phosphazene) [Clₓ(P═N)ₙ(R′₂O₃P)₂ₙ₋ₓ]

The poly(dichlorophosphazene) (23.2 g) with an element chlorine content of 0.1 mol and 0.1 mol of triethylphosphite (16.6 g) were respectively weighed and respectively dissolved in 100 mL of xylene (dried). The two solutions were mixed in a three-necked flask equipped with a stirrer, a condenser pipe and a heating device under stirring, stirred and reacted at 100-120° C. for 5-7 h. After the solvent was removed by evaporation, the reaction mixture was washed with an appropriate amount of petroleum ether 3-4 times to remove impurities, suction filtration was carried out, and the solid was dried in a vacuum drying oven at 60-100° C. to obtain a solid powder product [Clₙ(P═N)ₙ(Et₂O₃P)ₙ].

[Clₓ(P═N)ₙ(Et₂O₃P)₂ₙ₋ₓ] could be obtained by using different molar ratios of raw materials.

Using the same method above, other phosphate compounds [Clₓ(P═N)ₙ(R′₂O₃P)₂ₙ₋ₓ] could be obtained by replacing ethyl phosphite with other phosphites (one or a mixture of several of trimethylphosphite, tripropylphosphite or triisopropylphosphite).

### [Example 3]: Synthesis of Intermediate [(i-C₃H₇-ph-O)ₓ(P═N)ₙ(Et₂O₃P)₂ₙ₋ₓ]

In a three-necked flask equipped with electric stirrer and a condenser pipe under the protection of nitrogen, 0.1 mol (21.75 g) of the [Clₙ(P═N)ₙ(Et₂O₃P)ₙ] in the experiment of (2) above was dissolved in tetrahydrofuran, the solution was slowly added dropwise to 0.11 mol (17.38 g) of p-isopropyl-phenolate sodium in tetrahydrofuran, and the mixture was stirred at 80° C. to react for 24 h. After the completion of the reaction, the reaction mixture was cooled and neutralized with glacial acetic acid to neutrality, the mixture was stood and cooled in an ice water bath to separate a crystal, suction filtration was carried out, and the obtained crude product was recrystallized with tetrahydrofuran to obtain the pure product white crystal [(i-C₃H₇-ph-O)ₙ(P═N)ₙ(Et₂O₃P)ₙ].

Using the same method, different structures of [(i-C₃H₇-ph-O)ₓ(P═N)ₙ(Et₂O₃P)₂ₙ₋ₓ] could be obtained by selecting different mass ratios.

Using the above method, other phenolates may be used instead of alkylphenylphenolate (the other phenolates were: R in the aromatic phenolate (R—Ar—ONa) was C₁-C₈ alkyl, disubstituted C₁-C₈ alkyl or CH₂═CH—(CH₂)ₙ— (n=1-6); and Ar was one or a mixture of several of ph-, -ph-, naphthyl, disubstituted naphthyl, furyl, pyridyl, pyrazinyl, thienyl, imidazolyl and benzimidazolyl.) to react with intermediates reactive to other phosphites to obtain intermediates [(R—Ar—O)ₓ(P═N)ₙ(R′₂O₃P)₂ₙ₋ₓ] substituted by other phenolates and substituted by other phosphites.

### [Example 4]: Preparation of Novel Flame-Retardant Lithium Salt [(R—Ar—O)ₓ(P═N)ₙ(Li₂O₃P)₂ₙ₋ₓ]

[Method I] Hydrolysis in Lithium Hydroxide Solution

According to the method, an excess of lithium hydroxide was needed. A certain amount of [(R—Ar—O)ₓ(P═N)ₙ(R′₂O₃P)₂ₙ₋ₓ] was weighed and dispersed in a 2 mol/L lithium hydroxide solution. The mixture was heated, stirred and refluxed for 24 h. After ethanol generated by the hydrolysis reaction was removed by evaporation, the mixture was concentrated, cooled and stood overnight to obtain a crude product. The crude product was recrystallized twice with an ethanol-water mixed solution to obtain a colorless crystal [(R—Ar—O)ₓ(P═N)ₙ(Li₂O₃P)₂ₙ₋ₓ]. The mother liquor uses a cation exchange resin to collect and recover lithium ions.

[Method II] Hydrolysis in Sodium Hydroxide Solution.

Method II was the same as Method I, except that: the lithium hydroxide solution was replaced by a sodium hydroxide solution to obtain the colorless crystal [(R—Ar—O)ₓ(P═N)ₙ(Na₂O₃P)₂ₙ₋ₓ], and a solution prepared was exchanged with a cation exchange resin for 24 h to obtain [(R—Ar—O)ₓ(P═N)ₙ(H₂O₃P)₂ₙ₋ₓ], and the acid structure was reacted with an equimolar amount of lithium hydroxide (or a slightly excess amount, the pH of the solution was 9-11) to obtain the colorless crystal [(R—Ar—O)ₓ(P═N)ₙ(Li₂O₃P)₂ₙ₋ₓ] product.

### Example 4

Using the above method, other phenolates may be used instead of alkylphenylphenolate (the other phenolates were: R in the aromatic phenolate (R—Ar—ONa) was C₁-C₈ alkyl, disubstituted C₁-C₈ alkyl or CH₂═CH—(CH₂)ₙ— (n=1-6); and Ar was one or a mixture of several of ph-, -ph-, naphthyl, disubstituted naphthyl, furyl, pyridyl, pyrazinyl, thienyl, imidazolyl and benzimidazolyl.) to obtain products substituted by other phenolates.

Preparation process conditions, yields, solubilities, flame-retardant properties, conductivities and other data of various lithium salts are shown in Table 1.

### [Example 5]: Research of Compounding Process of Electrolyte

The [(R—Ar—O)ₓ(P═N)ₙ(Li₂O₃P)₂ₙ₋ₓ] was mixed and compounded with the [(R—Ar—O)ₓ(P═N)ₙ(R′₂O₃P)₂ₙ₋ₓ] according to a mass ratio of 10:1-1:1; and the mixture was dissolved in a suitable organic solvent. The solvent used was as follows: one or a mixture of several of methyl carbonate, ethyl carbonate, propyl carbonate, ethylene carbonate, fluoroethylene carbonate, dim ethyl sulfoxide, dimethylformamide, dimethylacetamide and N-methylpyrrolidone was used as the solvent of the electrolyte. The solution in which the novel flame-retardant electrolyte was dissolved was used as the additive of the novel flame-retardant lithium-ion battery electrolyte.

### [Example 6]: Preparation of Liquid Electrolyte

According to the novel flame-retardant electrolyte additive obtained in Example (5), a series of lithium-ion battery additives were added, for example: an anti-overcharge additive, such as one or a mixture of several of diacetylferrocene, transition metal complex of bipyridine, terpyridine or o-phenanthroline, anisole, cyclohexylbenzene and N-phenylmaleimide, with a mass percentage of 6%-25%; and an additive that promotes formation of an SEI, such as one or mixture of several of fluoroethylene carbonate, fluoropropylene carbonate, nonafluorobutyl ethyl ether, butane sultone, 1,3-propane sultone, vinyltrimethoxysilane, 2-phenylimidazole and 4-fluorophenylisocyanate, with a mass percentage of 4%-20%.

### [Example 7]: Performance Test of Liquid Electrolyte

The liquid electrolyte was tested for various physical and chemical performance indicators, such as flame-retardant properties, lithium-ion conductivity and other properties. The formula and compounding process of the liquid electrolyte were improved through the performance test to seek for a preparation process of a liquid electrolyte with more excellent performances.

Various liquid electrolyte formulae and compounding processes as well as test results such as viscosity, flame-retardant properties, conductivity and the like are shown in Table 2.

### [Example 8]: Assembly and Performance Test of Lithium-Ion Battery

The battery assembled with the novel flame-retardant liquid electrolyte was tested for battery performance, initial power generation performance, charge and discharge performance at different rates, cycle stability, battery overheating resistance, puncture resistance, anti-overcharge performance and the like.

### [Example 9]: Assembly and Performance Test of Lithium-Sulfur Battery

### [Example 10]: Assembly and Performance Test of Lithium-Oxygen Battery

The lithium-sulfur battery and the lithium-oxygen battery assembled with the novel flame-retardant liquid electrolyte were respectively tested for battery performance. Various aspects of performance of the novel flame-retardant liquid electrolyte were investigated.

The performance of various batteries assembled with different liquid electrolytes are shown in Table 2.

TABLE 1
Composition, yield, solubility, conductivity and flame-retardant properties of lithium salt
[(R—Ar—O)ₓ(P═N)ₙ(Li₂O₃P)₂ₙ₋ₓ]

| | | Relationship | | | | Limiting | |
|---|---|---|---|---|---|---|---|
| | | between | | | Conductivity | Oxygen | Fire Rating |
| R | Ar | n and x | Yield | Solubility | (S/cm) | Index (LOI) | (UL-94) |
| Me | R—Ph— | n = x | 73% | 31% | 0.025 | 41 | Non-combustible |
| Et | 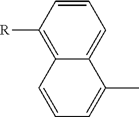 | n > x | 78% | 34% | 0.034 | 42 | Non-combustible |
| n-Pr | 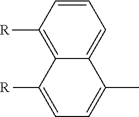 | n < x | 82% | 39% | 0.030 | 44 | Non-combustible |
| i-Pr | 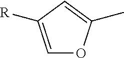 | n > x | 75% | 33% | 0.036 | 42 | Non-combustible |
| n-Bu | 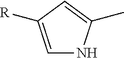 | n = x | 72% | 38% | 0.038 | 42 | Non-combustible |
| i-Bu | 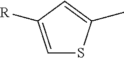 | n < x | 71% | 42% | 0.030 | 45 | Non-combustible |
| s-Bu | 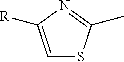 | n > x | 83% | 33% | 0.042 | 42 | Non-combustible |
| CH₂═CH(CH₂)₃— | 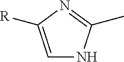 | n = x | 81% | 40% | 0.041 | 43 | Non-combustible |
| CH₂═CH(CH₂)₄— | 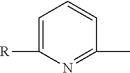 | n > x | 84% | 35% | 0.045 | 42 | Non-combustible |
| n-Pr | 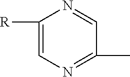 | n < x | 85% | 45% | 0.029 | 46 | Non-combustible |
| CH₃(CH₂)₆CH₂— | 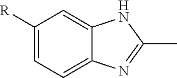 | n > x | 74% | 35% | 0.046 | 45 | Non-combustible |
| CH₃(CH₂)₅CH₂— | 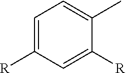 | n = x | 80% | 41% | 0.038 | 43 | Non-combustible |
| n-Bu | 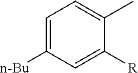 | n > x | 83% | 36% | 0.048 | 42 | Non-combustible |
| CH₃(CH₂)₆CH₂— | 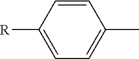 | n = x | 85% | 45% | 0.051 | 41 | Non-combustible |
| CH₂═CH(CH₂)₄— | 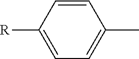 | n = x | 82% | 43% | 0.043 | 42 | Non-combustible |

TABLE 2
Formula, conductivity, flame-retardant properties of liquid electrolyte and battery performance

| | | | | | | | | | | | Lithium-oxygen |
|---|---|---|---|---|---|---|---|---|---|---|---|
| | | Flame-retardant | | Lithium-ion Battery ^{#} | | | | | | | Battery |
| | | Properties | | First | | | | Lithium-sulfur Battery ^{&} | | | First |
| | | Limiting | | Discharge | | | | First | | | Discharge |
| | | Oxygen | Fire | Capacity | Coulombic | D_{Li} | | Discharge | Coulombic | | Capacity |
| | Conductivity | Index | Rating | (0.1 C., | Efficiency | Value | LSV | Capacity | Efficiency | Capacity | (0.1 C., |
| Formula * | (S/cm) | (LOI) | (UL-94) | mAh/g) | (%) | (cm²/s) | (V) | (0.1 C., mAh/g) | (%) | Retention | mAh/g) |
| 1 | 0.032 | 40 | Non- | 198 | 96% | 3.37 × 10⁻⁹ | 5.1 | 1045 | 98 | 80% | 3210 |
| | | | combustible | | | | | | | | |
| 2 | 0.028 | 42 | Non- | 206 | 97% | 4.28 × 10⁻⁹ | 5.2 | 1124 | 99 | 89% | 2106 |
| | | | combustible | | | | | | | | |
| 3 | 0.036 | 42 | Non- | 210 | 97% | 5.34 × 10⁻⁹ | 5.2 | 1213 | 99 | 90% | 3697 |
| | | | combustible | | | | | | | | |
| 4 | 0.031 | 40 | Non- | 213 | 98% | 4.02 × 10⁻⁹ | 5.2 | 1138 | 99 | 90% | 3287 |
| | | | combustible | | | | | | | | |
| 5 | 0.026 | 41 | Non- | 185 | 97% | 2.01 × 10⁻⁹ | 5.0 | 1012 | 98 | 89% | 2396 |
| | | | combustible | | | | | | | | |
| 6 | 0.041 | 42 | Non- | 225 | 98% | 6.78 × 10⁻⁹ | 5.2 | 1326 | 99.5 | 91% | 5102 |
| | | | combustible | | | | | | | | |

NOTE
* Formula of liquid electrolyte:
1: The lithium salt was [(n-Bu-ph-O)ₙ(P═N)ₙ(Li₂O₃P) ₙ], the ester intermediate was (n-Bu-ph-O)ₙ(P=N)ₙ((C₂H₅)₂O₃P) ₙ], and the mass ratio of the two was 5:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 30%. The other additives and mass percentages thereof were respectively: 3% diacetylferrocene, 3% anisole, 2% butane sultone, 2% 1,3-propane sultone and 5% 2-phenylimidazole. 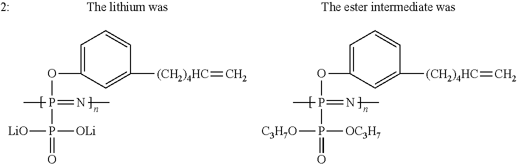
The mass ratio of the two was 6:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 35%. The other additives and mass percentages thereof were respectively: 4% di acetyl ferrocene, 3% transition metal complex of o-phenanthroline, 2% butane sultone, 3% nonafluorobutyl ethyl ether and 4% vinyltrimethoxysilane. 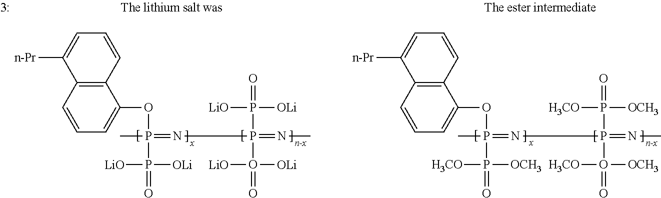
The mass ratio of the two was 7:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 36%. The other additives and mass percentages thereof were respectively: 2% di acetyl ferrocene, 4% N-phenylmaleimide, 3% butane sultone, 3% 1,3-propane sultone and 4% 4-fluorophenylisocyanate. 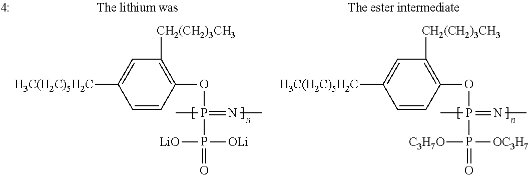
The mass ratio of the two was 4:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 37%. The other additives and mass percentages thereof were respectively: 4% di acetyl ferrocene, 3% anisole, 4% butane sultone, 3% vinyltrimethoxysilane and 4% 2-phenylimidazole. 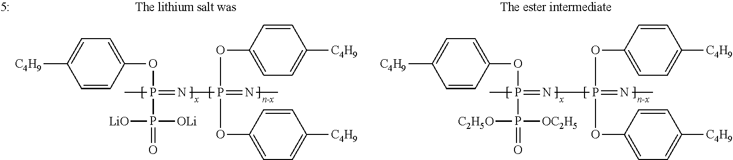
The mass ratio of the two was 10:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 30%. The other additives and mass percentages thereof were respectively: 4% diacetylferrocene, 5% nonafluorobutyl ethyl ether, 3% butane sultone, 3% vinyltrimethoxysilane and 4% 2-phenylimidazole. 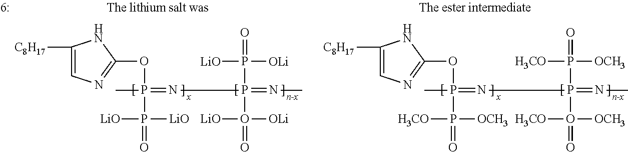
The mass ratio of the two was 5:1. The organic solvent was a mixture of ethyl carbonate, propyl carbonate, ethylene carbonate, fluoroethylene carbonate, dimethylsulfoxide, dimethylacetamide and N-methylpyrrolidone, with a mass percentage of 34%. The other additives and mass percentages thereof were respectively: 4% di acetyl ferrocene, 2% anisole, 3% butane sultone, 4% 1,3-propane sultone and 2% 2-phenylimidazole.
^{#} Lithium-ion battery
A commercial ternary lithium-ion battery was used, and the liquid electrolyte was the liquid electrolyte of the invention. The battery performance was tested according to GB/T18287.
^{&} Lithium-sulfur batteryLithium-sulfur battery capacity retention test: 10 cycles at 1 C..

Safety Performance of Batteries

The safety performance of all the batteries were better than that using the commercial liquid electrolyte under various test conditions. For example, the batteries of the invention did not become swollen in water; the temperature resistance could be increased to 80-100° C.; and the puncture resistance, compression resistance and bending resistance were greatly improved.

1. A preparation method of a flame-retardant lithium-ion battery electrolyte easily soluble in an organic solvent,
wherein a lithium salt with a structural general formula [(R—Ar—O)ₓ(P═N)ₙ(Li₂O₃P)₂ₙ₋ₓ] is a lithium salt easily soluble in the organic solvent and having a flame-retardant function, the lithium salt is poly(lithium phosphate) phosphazene partially substituted by alkyl aromatic oxy groups, and since a molecule of the lithium salt has a large number of aromatic groups, a solubility of the lithium salt in an organic solvent is improved; the solubility of the lithium salt in the organic solvent is regulated by controlling an amount of substitution of the alkyl aromatic oxy groups in the molecule; due to the presence of aromatic rings, a compatibility of the lithium salt with an electrode material is improved; since the molecule contains lots of lithium ions that are releasable by ionization, the lithium salt has a good lithium ion conductivity; since the molecule contains a polyphosphazene group and a phosphate group with good flame-retardant properties, the lithium salt has good flame-retardant properties; the lithium salt is compounded with a phosphate intermediate thereof having a formula of [(R—Ar—O)ₓ(P═N)ₙ(R′₂O₃P)₂ₙ₋ₓ]) to obtain the flame-retardant lithium-ion battery electrolyte; and
wherein the preparation method a comprises the following steps:
1) heating a raw material hexachlorocyclotriphosphazene (HCCP) at 210-250° C. in a high-boiling-point solvent to carry out a ring-opening polymerization to obtain poly(dichlorophosphazene) (PDCP), dissolving the PDCP in a specific solvent, and carrying out a reaction with a certain amount of triphosphite at 100-120° C. to obtain partially phosphated poly(chloro(dialkoxyphosphate)phosphazene) [Clₓ(P═N)ₙ(R′₂O₃P)₂ₙ₋ₓ]; reacting the [Clₓ(P═N)ₙ(R′₂O₃P)₂ₙ₋ₓ] with alkyl aromatic phenolate sodium (R—Ar—ONa) to obtain [(R—Ar—O)ₓ(P═N)ₙ(R′₂O₃P)₂ₙ₋ₓ], and hydrolyzing the [(R—Ar—O)ₓ(P═N)ₙ(R′₂O₃P)₂ₙ₋ₓ] under alkaline conditions of lithium hydroxide to obtain [(R—Ar—O)ₓ(P═N)ₙ(Li₂O₃P)₂ₙ₋ₓ]; or carrying out a hydrolysis under conditions of sodium hydroxide to obtain [(R—Ar—O)ₓ(P═N)ₙ(Na₂O₃P)₂ₙ₋ₓ], carrying out an ion exchange on the [(R—Ar—O)ₓ(P═N)ₙ(Na₂O₃P)₂ₙ₋ₓ] with a cation exchange resin to obtain [(R—Ar—O)ₓ(P═N)ₙ(H₂O₃P)₂ₙ₋ₓ], and carrying out a neutralization reaction with the lithium hydroxide to obtain [(R—Ar—O)ₓ(P═N)ₙ(Li₂O₃P)₂ₙ₋ₓ];
2) compounding and mixing the [(R—Ar—O)ₓ(P═N)ₙ(Li₂O₃P)₂ₙ₋ₓ] with [(R—Ar—O)ₓ(P═N)ₙ(R′₂O₃P)₂ₙ₋ₓ] according to a certain ratio to obtain a mixture, and dissolving the mixture in the organic solvent to obtain an additive of the flame-retardant lithium-ion battery electrolyte;
3) adding the additive of the flame-retardant lithium-ion battery electrolyte obtained in step 2) to a commercially available liquid electrolyte with no flame retardant and lithium salt added originally to obtain the flame-retardant lithium-ion battery electrolyte; wherein the flame-retardant lithium-ion battery electrolyte has good flame-retardant properties, higher lithium-ion conductivity and better compatibility with electrodes; a battery assembled with the flame-retardant lithium-ion battery electrolyte has better battery performance, and higher flame-retardant properties and safety performance; and the flame-retardant lithium-ion battery electrolyte is used as an electrolyte for lithium-ion batteries, lithium-oxygen batteries and lithium-sulfur batteries.

2. The preparation method according to claim 1, wherein the high-boiling-point solvent used in the ring-opening polymerization of the HCCP is one or a mixture of several solvents selected from the group consisting of an aromatic solvent oil, diphenyl ether, sulfolane, glyceryl triacetate, pentaerythritoltetraacetate, polyethylene glycol diacetate, liquid paraffin and methylnaphthalene oil,
wherein the high-boiling-point solvent is a solvent having a boiling point of higher than 220° C. and stable to the hexachlorocyclotriphosphazene and the poly(dichlorophosphazene).

3. The preparation method according to claim 1, wherein the poly(dichlorophosphazene) has a viscosity average molecular weight of 40,000-100,000 Da.

4. The preparation method according to claim 1,
wherein the triphosphite is one or a mixture of several compounds selected from the group consisting of trimethylphosphite, triethylphosphite, tripropylphosphite and triisopropylphosphite,
wherein an alcohol generated by the hydrolysis reaction has a low boiling point and is easily removed by evaporation; and
a mass G of the PDCP is calculated according to G/232 to obtain a number of moles of an element chlorine in the PDCP, and
a molar ratio of the number of moles of the element chlorine to phosphite is 4:1-1:4.

5. The preparation method according to claim 1, wherein the specific solvent used to dissolve the PDCP in the reaction between the PDCP and the triphosphite is toluene, xylene, tetrachloroethylene or dioxane; wherein the specific solvent has good solubility to the PDCP and the triphosphite, and is inert and unreactive to the PDCP and the triphosphite.

6. The preparation method according to claim 1,
wherein R in the aromatic phenolate (R—Ar—ONa) is one selected from the group consisting of C₁-C₈ alkyl, disubstituted C₁-C₈ alkyl and CH₂═CH—(CH₂)ₙ— (n=1-6); and
Ar is one or more selected from the group consisting of ph-, -ph-, naphthyl, disubstituted naphthyl, furyl, pyridyl, pyrazinyl, thienyl, imidazolyl and benzimidazolyl.

7. The preparation method according to claim 1, in step 2,
wherein a mass ratio of the [(R—Ar—O)ₓ(P═N)ₙ(Li₂O₃P)₂ₙ₋ₓ] to the [(R—Ar—O)ₓ(P═N)ₙ—(R′₂O₃P)₂ₙ₋ₓ] is 10:1-1:1; and
the organic solvent used is one or a mixture of several solvents selected from the group consisting of methyl carbonate, ethyl carbonate, propyl carbonate, ethylene carbonate, fluoroethylene carbonate, dimethylsulfoxide, dimethylformamide, dimethylacetamide and N-methylpyrrolidone.

8. The preparation method according to claim 1, in step 3, wherein a mass percentage of the additive of the flame-retardant lithium-ion battery electrolyte compounded from the [(R—Ar—O)ₓ(P═N)ₙ(Li₂O₃P)₂ₙ₋ₓ] and the [(R—Ar—O)ₓ(P═N)ₙ—(R′₂O₃P)₂ₙ₋ₓ] added to the commercially available electrolyte is 8%-45%.
